(19) United States
(12) Patent Application Publication
(10) Pub. No.: US 2023/0052987 A1
(43) Pub. Date: Feb. 16, 2023

(54) SYSTEM AND METHOD FOR SOLENOID VALVE OPTIMIZATION AND MEASUREMENT OF RESPONSE DETERIORATION

(71) Applicant: DANFOSS POWER SOLUTIONS II TECHNOLOGY A/S, Nordborg (DK)

(72) Inventors: Mayura Arun Madane, Pune (IN); Prachi Zambare, Pune (IN); Prasanth Jyothi Prasad, Kerala (IN); Richa Mahesh Shinde, Pune (IN); Arjun Thottupurathu Rejikumar, Kerala (IN); Dipesh Chauhan, Pune (IN); Kailasrao Nilesh Surase, Pune (IN); Rohit Tejsingh Chauhan, Pune (IN); Ankit Jain, Pune (IN)

(21) Appl. No.: 17/784,361

(22) PCT Filed: Dec. 11, 2020
(86) PCT No.: PCT/EP2020/025574

§ 371 Date: Jun. 10, 2022

(30) Foreign Application Priority Data
Dec. 12, 2019 (IN) 201911051558

(51) Int. Cl. H01F 7/18; F02D 41/20; F15B 13/044; F15B 13/08; F15B 19/00

(52) U.S. Cl. CPC H01F 7/1844; F02D 41/20; H01F 7/1805; F15B 13/044; F15B 13/085; F15B 13/086; F15B 19/005; H01F 2007/1888

(57) ABSTRACT

A system and method for detecting faults and optimiz-ing power usage of solenoid valves. The method includes obtaining a current signature of the solenoid coil, using a dedicated circuit to detect various features and using a pulse width modulation controller optimize the power output of the system. Additionally, using machine learning, the system can be optimized using data from the dedicated circuit.

### CROSS-REFERENCE TO RELATED APPLICATION

This application is a National Stage application of International Patent Application No. PCT/EP2020/025574, filed on Dec. 11, 2020, which claims priority to Indian Patent Application No. 201911051558, filed on Dec. 12, 2019, the disclosure of each is incorporated herein by reference in its entirety.

### BACKGROUND

Many fluid power systems, such as hydraulic systems, include valves to regulate fluid flow. There are various types of valves used for different purposes such as direction control, pressure control, on/off flow control, and proportional flow control. Valves are often incorporated in machines used in various industrial and mobile applications including injection molding machines, high pressure processing machines, lathe machines and mobile machines. The number of valves used in a given machine can vary greatly.

Some fluid power systems include spool valves. A spool valve includes a regulating member in the form of a spool that moves linearly within a bore or passage defined by a valve body. The spool can include one or more lands that control fluid communication between ports defined by the valve body based on the linear position of the spool. In some systems, the regulating member is driven by a solenoid linear actuator. It is not uncommon for a single system to include up to 50 or more valves.

In example systems, the multiple valves are connected in series or parallel combinations. Failure of even a single valve can prevent the entire system from operating properly. Failure of valves due to spool faults can result in issues such as lack of pressure or lack of intended cylinder displacement. Two common types of spool faults include the spool being stuck completely (i.e. the spool does not move), or the spool having reduced or restricted movement. Some common causes for spool faults are contamination of the fluid or wear of parts.

Failure of a valve can lead to many problems that require time and money to repair. Failures of valves due to spool faults may be avoided if the spool faults can be detected and localized.

### SUMMARY

In general terms, the present disclosure is directed to systems and methods that provide for more cost-effective and/or otherwise improved operation of solenoid valves. Certain aspects relate to systems and methods that provide for enhanced solenoid-valve diagnostics (e.g., fault detection). Other aspects relate to systems and methods that control valve power consumption to allow solenoid valves to operate more efficiently.

One example is solenoid operated valve comprising: at least one coil and at least one regulating member, a controller that interfaces with an electrical current meter to monitor a current signature of the coil upon actuating the solenoid operated valve by operating the solenoid operated valve in an actuating mode in which a first power level is used to drive current through the coil, and the controller includes a processor and memory in electronic communication with the processor for executing a regulating member power optimization algorithm operable to: detect when the regulating member has begun to shift based on a sensed current of the current signature sensed by the electrical current meter, detect when the regulating member has reached a final position based on the sensed current of the current signature sensed by the electrical current meter, and shift the solenoid operated valve from the actuating mode to a hold mode once the regulating member has been determined to be in the final position. When the solenoid operated valve is operated in the hold mode a second power level is used to drive current through the coil, and the second power level is lower than the first power level. The second power level of the hold mode can be controlled by a pulse width modulation controllers. In other examples the controller includes an integrated circuit with the solenoid coil. The controller can detect when the regulating member has begun to shift by detecting when the current has switched from a positive to a negative slope. The controller can then detect that the regulating member has reached its final position by detecting that the current has switched from a positive slope to a negative slope and then back to a positive slope. The controller can use a first latch which is set to high output when the system detects a negative slope, when the controller detects a positive slope after the first latch's output state has been set to high, the controller uses a second latch which is then set to high, once both the first and second latches are set to high the controller switches the current to a hold state.

A different example solenoid operated valve comprises at least one coil and at least one regulating member, a controller that interfaces with an electric current meter to monitor a current signature of the coil upon actuating the solenoid operated valve and the controller monitors measured data from the electric current meter related to the current signature, the measured data includes measured operation values comprising: time required to reach a first peak in current time required to reach a first valley in current, time required to reach the maximum current output, the ratio of the time required to reach the first valley to the time required to reach the first peak, and the controller compares the measured operational values to baseline operational values stored in memory to monitor the health of the solenoid operated valve.

A method is disclosed for reducing unplanned downtime for a solenoid operated spool valve, the method comprising: determining a response time of a spool of the spool valve; determining a position of the spool of the spool valve; calculating a spool response time error value; calculating a spool valve position error value; comparing one or both of the spool response time error value and the spool valve position error value to threshold values; and generating an error signal when either or both of the spool response time error value and the spool valve position error value exceeds the threshold values.

In some examples, the step of determining a response time of the valve includes calculating a response time based on one or more of: a time to reach first peak current;

a time to reach last valley current; a time to reach 90% of maximum current; a number of dip points; and a minimum point near zero from an ideal current signature line.

In some examples, the calculating a response time step is performed with a regression model.

In some examples, the calculating a spool response time error value includes comparing the valve response time to a baseline response time.

In some examples, the baseline response time is determined during a training of the spool valve.

In some examples, the spool response time error is calculated as a percent change with respect to the baseline response time.

In some examples, the step of determining a position of the spool of the valve includes calculating a response time based on one or more of: a difference in the current at a first valley and a stable state current; a Euclidian distance between a reference stuck profile and a latest recorded current signature; a time to reach first peak current; a time to reach last valley current; a time to reach 90% of maximum current; and a ratio of the square of the current at a first valley and a current at the first peak.

In some examples, the calculating a position step is performed with a regression model.

In some examples, the calculating a position error value includes comparing the valve position to a baseline response time.

In some examples, the baseline response time is determined during a training of the spool valve.

In some examples, the spool response time error is calculated as a percent change with respect to the baseline response time.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic representation of an example system including a solenoid valve having features in accordance with the present disclosure.

FIG. 2 is a prior art solenoid valve where a linear variable differential transformer is used.

FIG. 2A is a cross section of the prior art solenoid valve shown in FIG. 2.

FIG. 3 is an example current signature produced from the solenoid valve of FIG.

FIG. 4 is a plot illustrating a current signature and also depicting where pulse width modulation control could be implemented to modify the current signature.

FIG. 5 depicts spool shift detection circuitry which can be wired with the solenoid coil of the solenoid valve of FIG. 1.

FIG. 6 depicts another spool shift detection arrangement which can be wired with the solenoid coil of the solenoid valve of FIG. 1.

FIG. 7 is a more detailed schematic showing the spool shift detection arrangement of FIG. 6.

FIG. 8 is a flow chart with details regarding how the spool detection circuit arrangement of FIG. 7 operates.

FIG. 9 is a plot with current data from a healthy spool.

FIG. 10A-C are plots of current signatures of solenoid operated valves illustrating the effects of different supply voltages, the supply voltages of the tests are 28.8 V, 24V, and 19.2V respectively.

FIG. 11A-C are plots illustrating how solenoid valve's current signatures can be altered with temperatures. The tests were run at O C, 25 C, and 55 C respectively.

FIG. 12 is a plot of showing how the current signature for a solenoid valve varies based on the viscosity of the fluid flowing through the solenoid valve.

FIG. 13 is a plot showing how the current signature of a solenoid valve varies based upon the contamination level of the fluid flowing through the valve.

FIG. 14 is a flowchart illustrating how a solenoid valve can be trained using a linear regression method.

FIG. 15 is a flowchart illustrating how the solenoid valve can use the information from the linear regression of FIG. 14.

FIGS. 16A and 16B are plots directly comparing a healthy valves current signature with a valve that has a lower voltage to simulate a sluggish spool, shown in FIG. 16A, or an oil with a higher viscosity to simulate a sluggish spool, shown in FIG. 16B.

FIG. 17 is schematic example current signature produced from the solenoid valve of FIG. 1 superimposed over an ideal signature line.

FIG. 17A shows the schematic example of FIG. 17 with annotation showing how the ideal signature line is determined.

FIG. 18 is a schematic regression logic model calculating an ideal spool response time.

FIG. 19 is an exemplary flow chart with process details regarding how the spool detection circuit arrangements disclosed herein may operate to detect spool response time deterioration.

FIG. 20 is an exemplary flow chart with process details regarding real time evaluation of the spool response time deterioration identified through the process shown at FIG. 19.

FIG. 21 is an exemplary flow chart with process details regarding how the spool detection circuit arrangements disclosed herein may operate to detect spool position deterioration when pretrained models are available.

FIG. 22 is an exemplary flow chart with process details regarding real time evaluation of the spool position deterioration identified through the process shown at FIG. 20.

FIG. 23 is an exemplary flow chart with process details regarding real time evaluation of the spool position deterioration using a regression model derived from an online learning phase.

### DETAILED DESCRIPTION

Various examples will be described in detail with reference to the drawings, wherein like reference numerals represent like parts and assemblies throughout the several views. Additionally, any examples set forth in this specification are not intended to be limiting and merely set forth some of the many possible examples in accordance with the principles of the present disclosure.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

When valves of a mechanical system deteriorate or wear out, the position of flow or pressure regulating members of those valves, such as the spool of a solenoid operated valve, can deviate from what is expected from a given operating command on the system, resulting in, e.g., too much or too little flow, an undesirable pressure differential across the valve, etc. Such abnormal spool operation can be caused by contamination of the fluid or wear of the parts of the valve. It is therefore beneficial to detect such deviations during operation of the system so that command inputs can be adjusted to achieve the desired flow/pressure, and also to prevent against system failure and consequences thereof, such as breakdown of the machinery/equipment.

Certain aspects of the present disclosure are directed to monitoring the spool of a solenoid operated valve. In some embodiments, and by non-limiting example, a system and method for monitoring the spool of a solenoid operated valve includes a solenoid coil and spool. In some embodiments the systems and methods incorporate an electrical current meter and a processor and a memory in electronic communication with the processor for executing a spool fault detection algorithm.

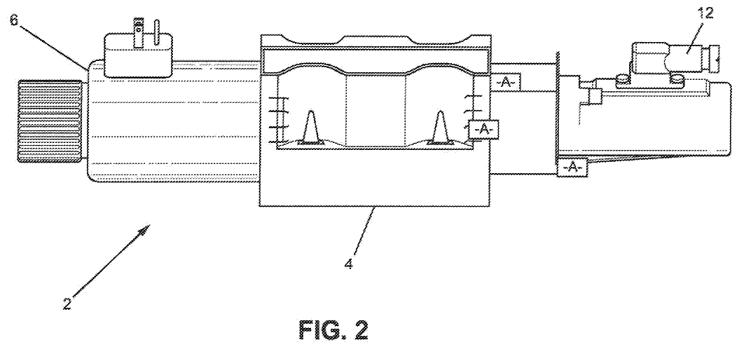

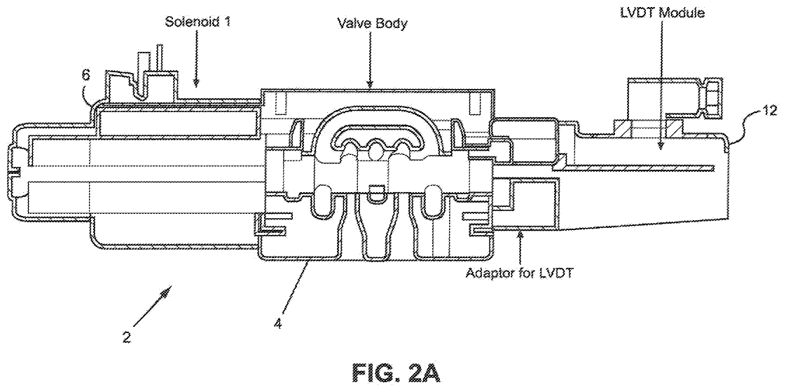

In typical hydraulic spool valve assemblies, spool position is detected using a linear variable differential transformer (LVDT) 12 coupled directly to a spool 2 shown in FIGS. 2 and 2A. LVDT 12 is coupled adjacent to a valve body 4 which is adjacent to a solenoid 6 of the spool 2. However, LVDT's are expensive and can be damaged over time by being subjected to the high pressure hydraulic fluid in the flow passage in which they are positioned. The system and methods of monitoring the spool of a solenoid operated valve of this disclosure may be implemented without direct measurement of spool position or the need for extra sensors such as LVDTs, but rather infer spool position from measurements of other measured parameters of the valve, e.g. measured solenoid coil current. In addition, the system and method disclosed may be performed “in real time,” where detection may be reported near-instantaneously and concurrently allowing for continuous monitoring with little appreciable delay between detection and reported results.

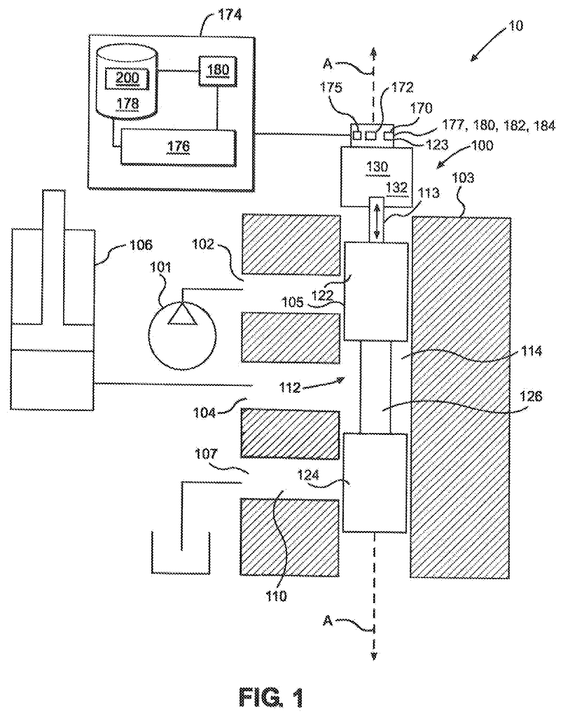

FIG. 1 represents a mechanical system 10 that at least partially operates through the use of hydraulics. The hydraulics include a non-limiting embodiment of valve assembly 100 used to illustrate principles of the present disclosure. In some examples, the valve assembly 100 is an On-Off valve. The valve assembly 100 includes a housing 103 (e.g., a valve block or valve body) housing a spool 112 mounted in a spool bore 114 defined by the housing 103. In this example, the spool valve is a three-way spool valve. However, the principles of the present disclosure are readily applied to other spool valves (e.g., two-way spool valves) and other fluid control valves, e.g. flow control valves with on/off or poppets. The spool 112 includes a shaft 126 coupled to a pair of metering lands 122 and 124 on either end of the shaft 126, each land providing a flow regulation function of the valve assembly 100. A solenoid linear actuator 130 is coupled to the spool 112 and is adapted to drive axial linear movement of the spool 112 within the spool bore 114, the linear movement being along the central axis A of the spool bore 114. Solenoid linear actuator 130 houses a coil 132, which is used to generate a controlled magnetic field by the application of a control or command signal that generates a current in the coil 132.

A fluid supply 101 (e.g., a pump) supplies hydraulic fluid via a supply line 102 through a supply port 105 to a work port 104. The work port 104 is connected to a hydraulic cylinder 106 that drives a load, i.e., a load of a piece of hydraulic equipment or machinery. Fluid from the work port empties to the tank 108 via a tank port 107 and a tank line 110.

A control unit 170 is configured to provide control or command signals that generate current in the coil 132 to drive axial linear movement of the spool 112 along the axis A The control unit also includes an electrical current meter 173, e.g., an ammeter, adapted to measure electrical current in the coil or coils 132 of the solenoid linear actuator 130. The spool 112 is moved within the valve body between a closed position (e.g., an off-position where flow is blocked, shown at FIG. 1) and first and second open positions (e.g., on-positions where flow is permitted through the valve body. In the closed position, the spool 112 blocks fluid communication between the supply port 105, the work port 104 and the tank port 107. In the first open position, the spool 112 is moved to open fluid communication between the supply port 105 and the work port 104 such that pressurized hydraulic fluid from the supply port 105 flows into the hydraulic cylinder 106 to drive movement of the hydraulic cylinder 106 from a first rod position toward a second rod position. In the second open position, the spool 112 is moved to open fluid communication between the work port 104 and the tank port 107 such that hydraulic fluid from the hydraulic cylinder 106 can flow to tank to allow the hydraulic cylinder 106 to move from the second rod position back toward the first rod position.

Measurements from the electrical current meter 173 are fed to an operating subsystem 174 of the mechanical system 10, the operating subsystem 174 being operatively coupled to the control unit 170. The operating subsystem 174 includes one or more processors 180 adapted to execute computer readable instructions and to process signals received from the control unit. The operating subsystem 174 also includes a memory 178 that stores computer readable instructions and a command interface 176, both operatively coupled to the one or more processors 180.

As the solenoid linear actuator 130 receives electrical current to drive axial linear movement of the spool 112 within the spool bore along the axis A, a portion 113 (e.g., a ferromagnetic portion, armature portion, etc.) of the spool 112 or a portion of a spool assembly that includes the spool 112 and is fixedly coupled to the spool 112 moves relative to the one or more coils of the solenoid linear actuator 130, causing the magnetic flux through the coil or coils 132 to change, which likewise generates an inductance in the coil or coils. The inductance generated in the coils due to these magnetic field interactions with the spool 112 or portion 113 causes the current in the coil or coils 132 to change. The current in the coil or coils 132 is different depending on whether the spool 112 actually moved, did not move, or has completed a movement. The current in the coil or coils 132 may be measured by the electrical current meter 173 as a function of time. Such measurements of the current in the coil or coils 132 may be visualized as a plot of coil current as a function of time over a period of time and referred to as a “current signature.” One current signature can correspond to movement of the spool 112 from the closed position to the first open position, and another current signature can correspond to movement of the spool 112 from the closed position to the second open position.

A spool fault condition may be generated by the control unit 170 to indicate whether the spool 112 moved normally, e.g. as expected and intended, in response to a control or command signal. In cases where the spool 112 moves normally through its full stroke length (e.g. the full length between the closed position and one of the open positions) in response to the control or command signal, the control unit may indicate a negative spool fault condition, that is, there is no spool fault. In cases where the spool 112 does not move normally in response to the control or command signal, the control unit 170 may indicate a positive spool fault condition, that is, there is a spool fault. When the spool 112 does not move normally, it may move partially through its intended stroke length in response to the control or command signal, or it may not move at all, and the resulting spool fault condition indicated by the control unit 170 may also indicate whether the spool 112 moved at all and how much it moved. The spool fault condition reported by control unit 170, whether negative or positive and what type of positive spool fault (e.g. no movement at all or partial movement) is based on the current signature measured by the electrical current meter 173.

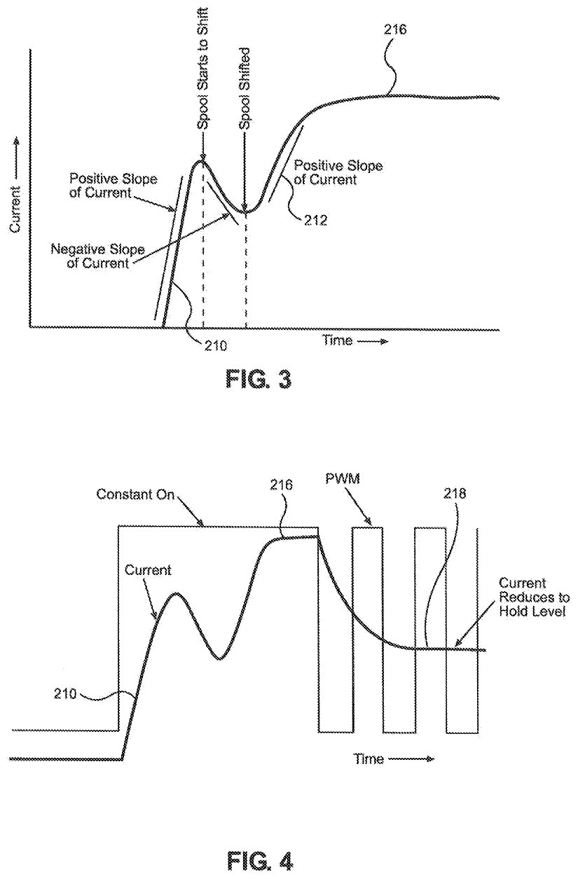

An example current signature is shown in FIG. 3. A current signature 200 is characterized by the current rising 210 as a magnetic field develops in the center of the coil 132. When the magnetic field is strong enough to push the spool and overcome the spring force the spool starts to move through the center of the coil 132 which causes opposing voltage to develop in the coil 132 due to sudden change in magnetic field or inductance of the coil 132, this leads the current to reduce. Once the spool is shifted completely the current will continue to rise 212 to a continuous peak 216 level completing the current signature. There are ways to use the data from the current signature to both detect faults in the spool and also optimize power usage to extend the life of the solenoid valve.

One embodiment uses the data collected to optimize power usage through the use of a pulse width modulation controller (PWM). This embodiment is shown in FIG. 4 over a graph of the current signature. The continuous peak current 216 is not required to keep the spool in position. Current can be reduced to a hold level 218 that is sufficient to keep the spool in position. Reducing the current through the solenoid coil 132 can reduce the power consumption of the valve system. Reduction in power consumption causes the temperature of the coil to remain at a lower level. Life cycles of coils are increased significantly when the temperature is kept at lower levels. The time required to shift the spool and the current signature depend on many factors. Some include coil specifications, load on the spool, spool friction force, and supply voltage. Spool shift detection and current reduction can be done by detecting the current and using a PWM to reduce coil current to hold level. PWM voltage control can be done by microcontroller or other ways.

However, accurately detecting the spool shifting can be accomplished using a dedicated hardware circuit to detect the spool shift and enable the PWM controller.

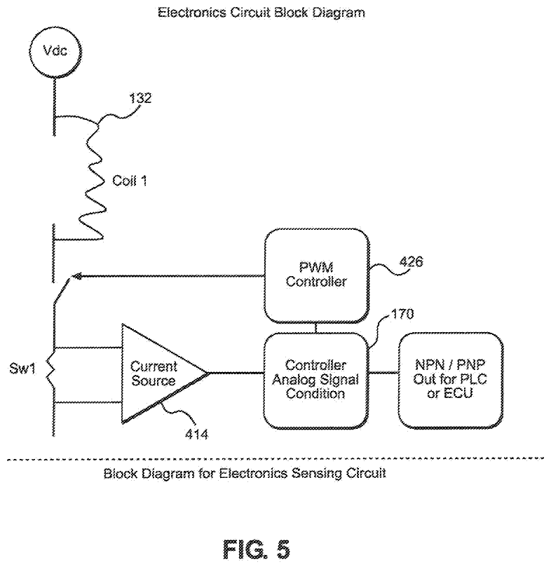

One embodiment which implements a dedicated circuit is to use a current sense block to detect the current while the spool is shifting as shown in FIG. 5. By using a current sense block 414, it is possible can sense and read the current flowing through the coil as the spool shifts. The coil current rate is di/dt=V/L (di/dt being the instantaneous rate of current change (amps per second), V being the voltage across the solenoid and L being inductance in Henrys. V is also calculated using V-V_{backemf} where V is equal voltage supply and V_{backemf} is equal to the counter electromagnetic force of the circuit. The rise in current is limited by the DC resistance of the coil path. Once the solenoid is energized, the current increases, this causes the magnetic field to expand until the force is strong enough to move the armature. The armature movement increases the concentration of the magnetic field. As the armature's own magnetic mass moves farther into the magnetic field the magnetic field creates an opposing voltage into the windings of the solenoid. Because the magnetic field quickly expands when the armature strokes, the field causes a brief reduction in the current

$$\frac{d i}{dt} = \frac{V - {V}_{b a c k e m f}}{L}$$

through the solenoid windings. Where di/dt is equal to the instantaneous rate of current change, V is equal to the supply voltage, V_{backemf} is equal to the reduction caused by the magnetic field expanding and L is the inductance. After the armature strokes, the current continues to rise to its maximum peak level. The current signature can be tracked and valley point can be used as an indication of complete spool movement. This will be used to provide the position indication. In addition, the signature will be used to provide trigger to switch into pulse width modulation (Hold) or completely on (Peak) mode for coil. Some benefits of using an integrated circuit detection include a simpler way to switch into peak and hold modes without requiring user configuration. In some embodiments sensors will not be required which will reduce cost, increase the ease of installation, assembly, and fault detection will be simplified using signature understanding.

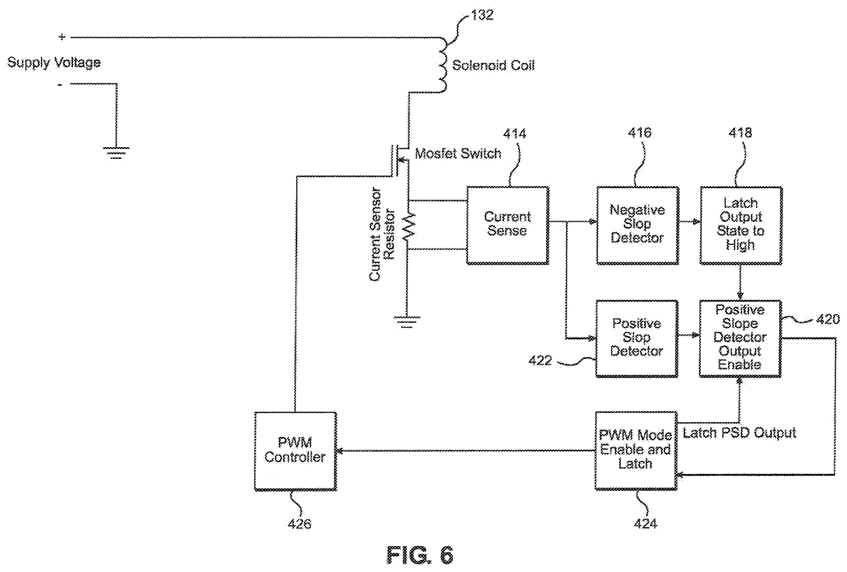

A different embodiment for spool shift detection by using a dedicated circuit is illustrated in the block diagram of FIG. 6. First, current passing through the coil 132 is detected by the current sense block 414. Output of the current sense block is provided to the negative and the positive slope detector block 416,422 which are wired in parallel. Typically, the current will rise until the magnetic field produced is sufficient to begin to move the spool. The positive slope will be detected, however if the negative slope detector latch output 418 has not been set to high the circuit will wait. Once the spool starts to move the current will begin to lower, this will cause the negative slope detector to be latched to high output. The slope of the current will start to go upward again, once the spool has moved to its final position. After the negative slope detector's output state is set to high and the current begins to rise the positive slope detector 422 can be latched 424 to high. After both the negative and positive slope detectors are set to high the PWM 30 controller 426 is enabled and will set the current to a hold position. This can lead to a decrease in power consumption and to a lower operating temperature. The negative and positive slope current pattern with the PWM in place is shown in FIG. 4.

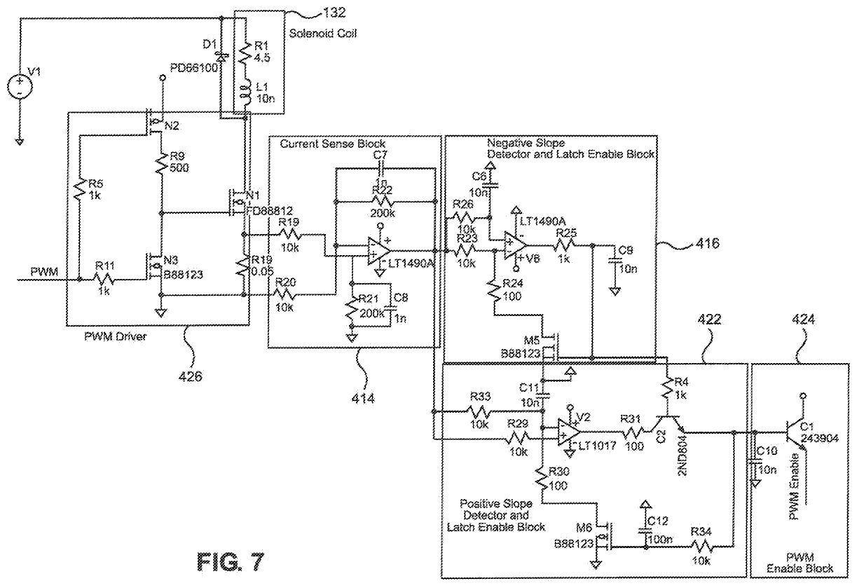

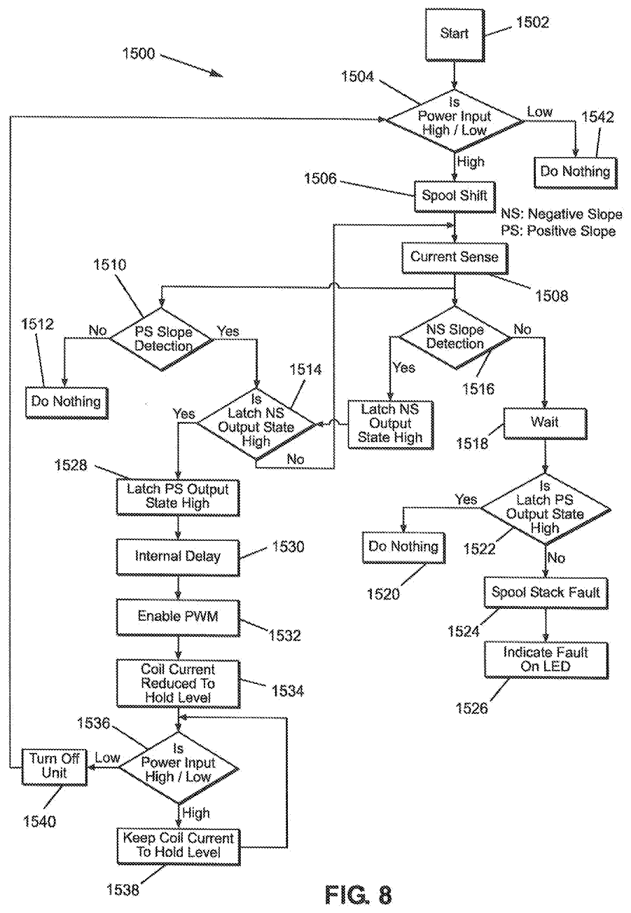

A specific example of a circuit using hardware that was made in LTSpice is shown in FIG. 7. LTSpice is a free software which implements a SPICE (simulation program with integrated circuit emphasis) electric circuit simulator. It is made by a component manufacturer, Linear Technology, which allows for specific components to be added. The components include the solenoid coil 132 which is wired in series with a PWM driver 426, the PWM driver 426 is then attached to a current sense block 414 which is wired in parallel with a negative and positive slope detector 416,422. As outlined above, once both the negative and positive slope detectors 416, 422 are latched to high output levels a PWM enable block which is wired in series with the negative slope detector block will be enabled. This will enable the PWM and reduce the current output to a hold position demonstrated in FIG. 4. An additional explanation of how the system 1500 will work is illustrated in the flow diagram of FIG. 8.

The system 1500 begins with a start block 1502, from the start block 1502 the system 1500 determines a power input 1504. If the power output is low the system 1500 does nothing 1542. If the power output is high the system goes to a spool shift block 1506. After the spool shift block 1506 there is a current sense block if the a negative or positive slope and then goes to a negative slope or positive slope block 1510, 1516. If the system 1500 goes to the positive slope block 1510 the system determines whether or not a negative slope output state 1514 is set to high. If it is not the system returns to the current sense block 1508. If the negative slope output 1514 is set to high the system 1500 triggers a latch positive slope output state 1528 to high. There is then an internal delay 1530 and a pulse width modulation control 1532 is enabled, this causes a coil current to reduce to a hold level 1534. The system then determines if the current coil is high or low, if it is high the system 1500 is shut off 1540 and the system 1500 returns to determining the power input 1504. If the positive slope detection 1510 is negative then the system does nothing. Returning to the current sense block 1508, if there is a negative slope detected, the system goes to the negative slope detection block 1516. From the negative slope detection box 1516 the system 1500 waits 1518 if there is a negative response, after waiting 1508 the system determines if the positive slope latch 1522 is set to high if it is not, a spool fault 1524 is detected and the fault LED 1526 is turned on. If there is positive response at the negative slope detection block 1516 the system 1500 does nothing 1520. Returning to the negative slope detection block 1516 if there is a positive slope response the system 1500 goes to determining the negative slope output state 1514. From the negative slope output state 1514 the system 1500 follows the path outlined previously after the positive slope detection block 1510 is positive.

An added benefit to using indirect method such as a dedicated circuit is that the circuit is able to monitor peaks and valleys of current signature valves. They additionally monitor peaks, valleys, slope, and magnitude of the current. This is what generates the current signature and can then be compared to previous current signatures to help detect issues which is an issue that currently used direct contactless position switches and proximity sensors, have issues detecting. Time based techniques may fail in cases where restricted spool movement has happened due to increased frictional force spool and valve body but time for movement still meets the specification of the spool.

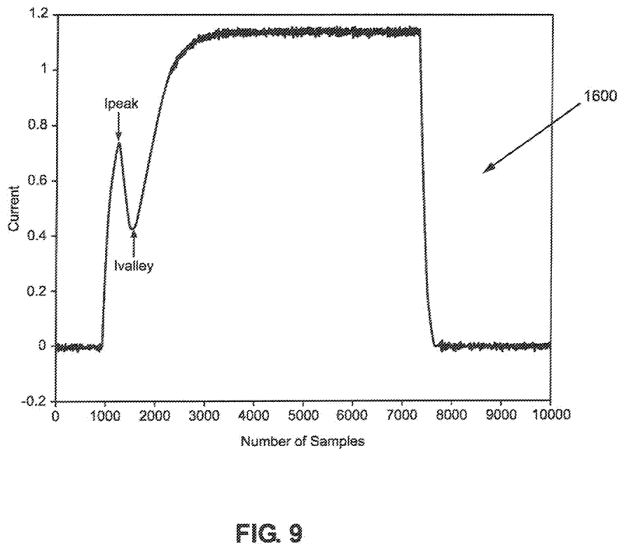

A plot of current from a healthy coil 1600 is illustrated in FIG. 9. A normal current signature depends on several variables including but not limited to: temperature, coil state, pressure, flow conditions, different sizes (flow capacity) of valves and more.

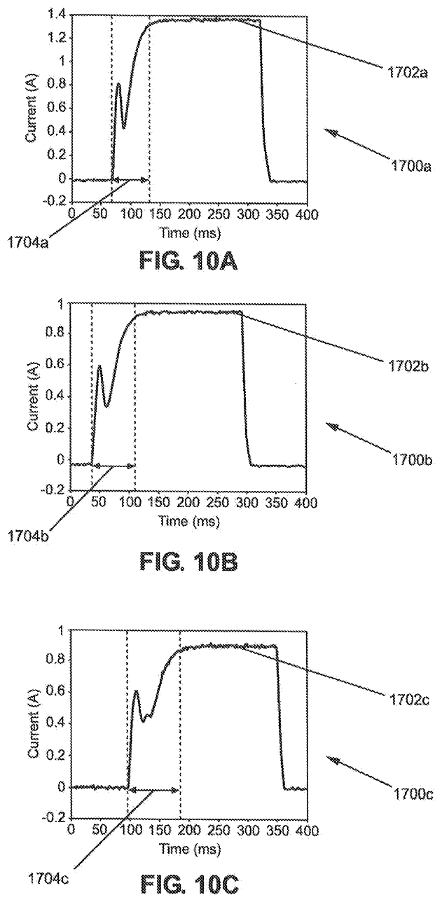

In order to determine which variables impact the current signature the most several studies were conducted to show that the signature patterns differ when operated under various conditions. These tests each included a healthy spool as a control. Plots illustrated in FIGS. 10A-C were tested using different voltages provided to the system. In FIG. 10A a current signature 1700a for a solenoid valve with a supply voltage of 28.8 V, the current signature 1700a has a current magnitude 1702a of about I.4 A, FIG. 10B exhibits a current signature I 700b for a solenoid valve with a supply voltage of 24 V with a current magnitude 1702b of 1.15 A, FIG. 10C shows a current signature 1700c supply voltage of 19.2 V with a current magnitude 1702c of 0.9 A The changes in voltage supply and current also changed the times required for the spool of the solenoid valve to shift from 55 ms 1704a shown in FIG. 10A to 70 ms 1704b shown in FIG. 10B to 85 ms 1704b shown in FIG. 10C. These plots demonstrate that voltage is a cause for sluggish spools and can lead to errors or issues with solenoid valves.

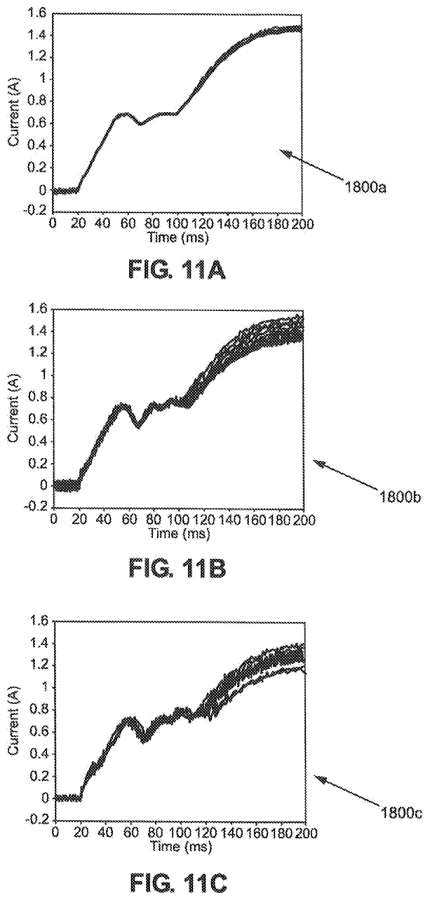

A study testing different temperatures effects on solenoid valves and their current signatures is illustrated in FIGS. 11A-C. FIG. 11A shows a current signature 1800a for a solenoid at O degrees Celsius, 11B shows a current signature 1800b at 25 degrees Celsius, and FIG. 11C shows a current signature 1800b at 55 degrees Celsius. Due to the dramatic differences demonstrated temperature can impact various operating parameters on measured signal levels, thus, methods based on stored levels or stored signatures can be ineffective.

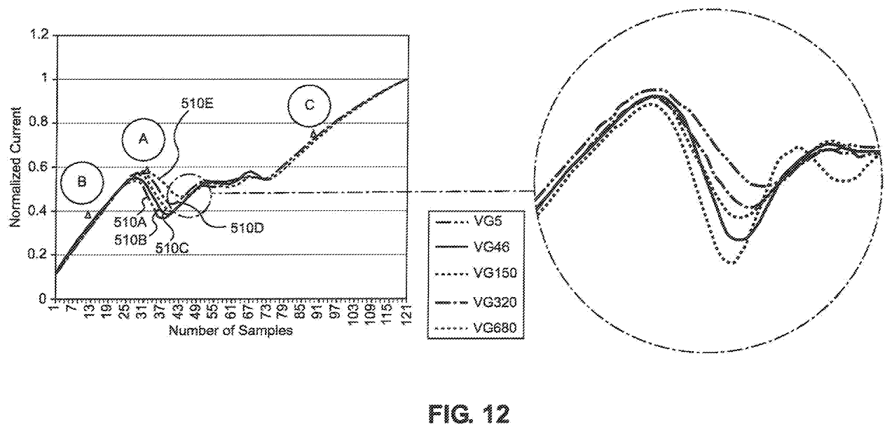

A different study, illustrated by the plot in FIG. 12 demonstrates sluggish spool movement from liquids of different viscosity levels. Five different levels were used, International Standards Organization Viscosity Grade (ISO-3448); ISOVG5, ISO-VG46, ISO-VG150, ISO-VG320, ISO-VG680. The plots of these are shown in FIG. 12 as 510A-D respectively. With increasing viscosity, the resistance to spool movement was increased while still allowing the spool to move complete stroke. Changes that can be observed in the current signature include; a normalized valley of current increased with the viscosity of the fluid, and the time to reach first valley increased with viscosity of the fluid. The magnitude of the peak current 512A and the initial slope 512B of current signature remain the same through-out the experiments indicating that same electromagnetic force is required to move the spool from its neutral position in each case. And the final slope 512C also being same, as spool is completing its full stroke in each case. This data demonstrates that higher viscosity of fluid creates a more sluggish spool.

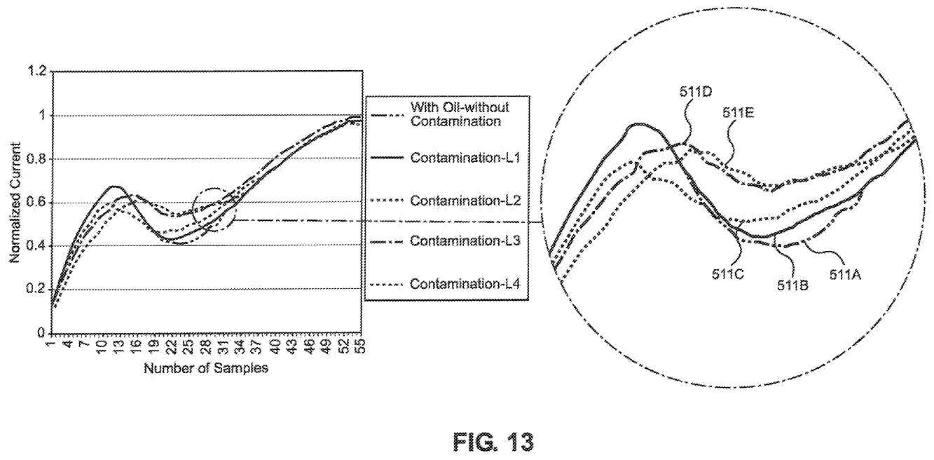

In a final test oil was contaminated with iron powder of particle size 6-10 microns and white grease. Concentration of particles in the oil was increased incrementally from Level 1 to Level 4. This is shown in FIG. 13 as 511A-E respectively with 511A being oil without contamination. The following changes can be observed in the current signature: normalized magnitude of peak current in contaminated state of oil are different from the oil in a healthy state, the time to reach the peak current is increased with increased contamination levels of oil, the normalized magnitude of valley current is increased with increasing concentration levels of contaminants in the oil, the time to reach the valley current in contaminated state of oil is different from the time in a healthy state. If the clearances between the spool and bore become filled with particles, more force is required to move the spool. The resulting current signatures vary, however, depending on where the contaminants fall within the spool. Results shown in FIG. 13 show normalized magnitude of peak current and initial slope is different in each case indicating that different electromagnetic force is required to move the spool from its position. This is shown in FIG. 13 for contamination Level 3 511D and Level 4 511E due to higher number of particles restricting the spool movement, spool is not able to complete the full stroke as the difference between magnitudes of peak current and valley current, as well as the difference between time to reach peak current and valley current both are reduced significantly.

As illustrated in FIG. 12 and FIG. 13, effects of spool response deterioration are predominantly seen in the area between the peak and the valley of the current signature. The following key features can be used to monitor response deterioration of solenoid valves using current signature: ratio of ‘normalized magnitude of valley current’ to ‘normalized magnitude of peak current’, time to reach peak current, time to reach valley current, and time to reach maximum current (settling current). To determine the impact of the features listed above on spool performance, a supervisory machine learning technique, linear regression is can be used. Using linear regression can give a cause-and-effect relationship between sluggish spool movement (dependent variable) and extracted features from current signature (independent/explanatory variables). The ratio of ‘normalized magnitude of valley current’ to ‘normalized magnitude of peak current is important because this ratio increases with increasing level of deterioration in the spool response. The time to reach peak current is important because it is a significant indication of the start of spool movement and may be affected in the case of restricted spool movement due to contamination particles. The time to reach the valley current, and the time to reach the maximum current are important because they are significantly affected by different voltages. Using these features, a best-fit predictive model can be developed. Each solenoid valve in its healthy state can be trained using this model and corresponding values are obtained from the regression model which serve as a reference to predict spool response deterioration over the time due to factors mentioned. This can assist when predicting the life of valves and assist with predicting how long the valves coil will last.

Along with the regression model, the present disclosure can use statistical process control (SPC) methods to monitor change in behavior of each key feature individually and in turn monitoring degradation of spool movement (response). As more data is acquired the algorithm will become more robust. In order to generate the algorithm the following: feature value in order over time (data): means of feature values obtained from training serving as average line, 2 standard deviations from the mean are set as upper and lower control limits, current in contaminated state of oil were different from the ones in healthy state of oil. Features being listed in the preceding paragraph.

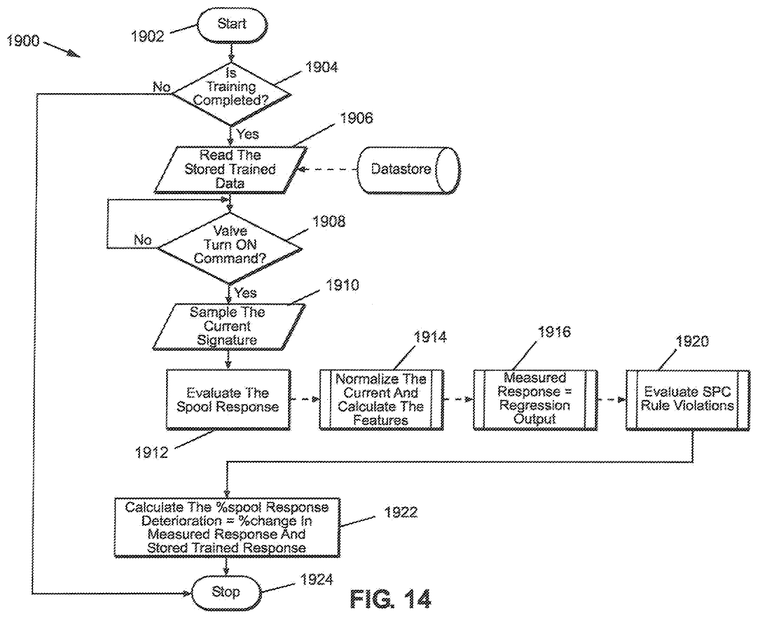

By using the linear regression models it becomes easier to detect when a failure may occur, what caused the failure, and can potentially predict when failures may occur. An example trained solenoid valve is shown in FIG. 14. A process 1900 of the real time spool response time deterioration algorithm is presented. At a step 1902 the process initiates either automatically or by command. At step 1904, an evaluation is performed as to whether training has been completed (e.g. via process 1000), whereby the process is stopped at step 1924 if training has not been completed or advances to step 1106 if training has been completed. At step 1106, the stored trained data (e.g. from process 1000) is read. At a step 1908, the process will stay in a holding loop at step 1108 until a valve turn ON command has been verified, after which the process advances to step 1110 at which the current signature of the valve is sampled. In steps 1912 to 1920, spool response time is evaluated. The measured current signature is normalized, and features are calculated at step 1914. These features, at step 1916, are scaled by using standardization technique to transform features into common range by using mean and standard deviation stored in learning phase. Step 1920 can be implemented to evaluate SPC (Statistical Process Control) rule violations. The calculated response time is used to compute the percent spool response time deterioration as a percent change in measured response time with respect to the stored trained response time from process 1000. The process can terminate at step 1924.

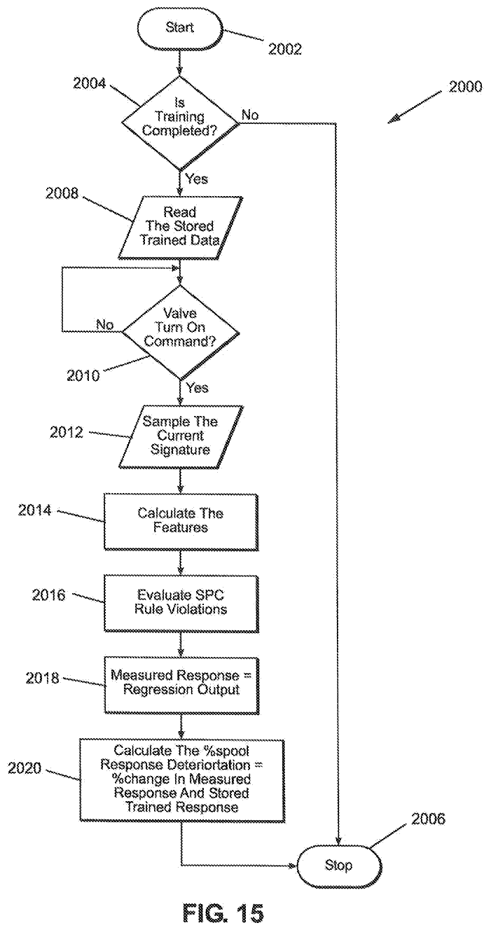

A way which a real time system evaluation could occur is shown through a system 2000 in FIG. 15. It begins at step 2002 by checking whether the system has been trained at step 2004, if it has not the real time evaluation stops 2006. If the system 2000 has been trained the system will read stored trained data at a step 2008 and evaluate whether a valve has been turned on through a system or otherwise at step 2010. If it has not the system 2000 will check again. If the valve has been turned on, the system 2000 will sample a current signature at step 2012 and calculate the features at step 2014, then evaluate whether the system 2000 has broken SPC rules at step 2016, followed by measuring the response as a regression output at step 2018 and then calculate the response deterioration in percent changed from the measured response and the response from the trained responses at step 2020.

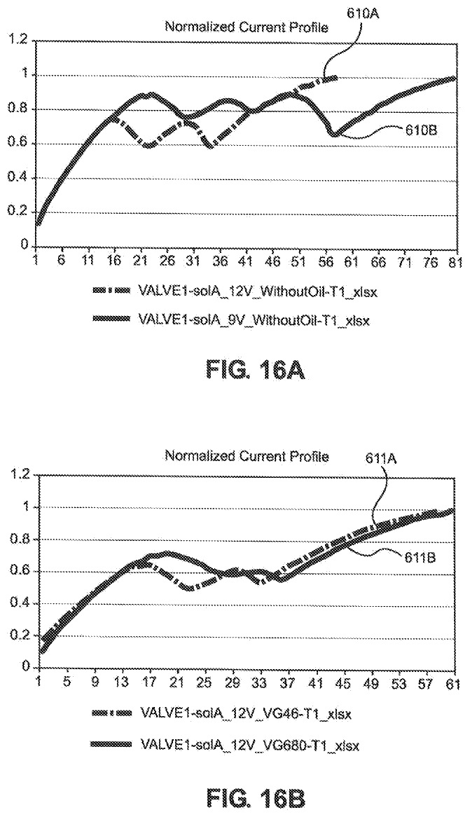

A specific example of where a linear regression equation based on the data collected can be used to determine the percent deterioration is shown in FIGS. 16A and B. In FIG. 16A the two current signatures are shown with a healthy current signature 610A, with the voltage through the solenoid being 12V. The sluggish spool current signature 610B has a voltage of 9V run through it. For the healthy spool the valley to peak ration is 0.786, the time to reach the first peak is 1 6 ms and the time to reach the first valley is 24 ms, and the time to reach the max current is 35 ms. In order to create a linear regression equation a statistical analysis software is typically used. One example is MiniTab. MiniTab is a software developed at Pennsylvania State University and distributed by MiniTab LLC. Minitab can automate calculations and create equations such as a linear regression equation using data. A linear regression equation typically takes some form of Y=a+bX where X is the explanatory variable and Y is the dependent variable. After using software to calculate a linear regression equation using the data above, Y is equal to 53.532 for this spool. For the explanatory variables peak to valley ratio (Ivalley/Ipeak), time to reach the first peak (Time to reach Ipeak), the time to reach the first valley (Time to reach Ivalley), and the time to reach the maximum current (Time to reach Imax). The peak to valley ratio for a sluggish spool (9V) is 0.851, the time to reach the first peak is 24 ms and the time to reach the first valley is 31 ms, the time to reach the maximum current is 60 ms. Using the equation generated from the healthy spool:

Y=(86.24*Ivalley/Ipeak)−(0.093*(Time to reach Ipeak))+(0.831*(Time to reach Ivalley))−(0.2019*(Time to reach I max))−25.61

Y is equal to 59.193 for the spool with a lower voltage.

In order to calculate the response deterioration percentage the following equation is used the dependent variable differences are used including yₗₐₜₑₛₜ which would be the most recent calculation, y_{training} which is the average result from training, and y_{worstcase} which is the regression equation output for the stuck case of the valve to make the following equation:

$$\frac{( {y}_{l a t e s t} - {y}_{t r a i n i n g} )}{( {y}_{w o r s t c a s e} - {y}_{t r a i n i n g} )}$$

Using this calculation for the sluggish spool simulated with a lower voltage there is a 17.307% response deterioration. Similarly, in FIG. 16B an example where a sluggish spool was demonstrated using an oil with a thicker viscosity is demonstrated. The healthy spool 611A the oil used is VG-46, valley to peak ration is 0.772 with a time to reach the first peak of 1 7 ms and a time to reach the first valley of 23 ms, the time to reach the maximum current was 33 ms. In the sluggish spool 611B VG680 oil was introduced. The time to reach the first peak was 20 ms with a time to reach the first valley at 29 ms, the time to reach the maximum current was 37 ms. Using the linear regression equation on the data Y is equal to 51.869 for the healthy spool and 60.397 for the sluggish spool. Using the equation to calculate response deterioration the response deterioration percentages are 0.001 and 24.811 respectively. Using data to create a linear regression model is beneficial to helping prevent errors and can assist with foreseeing errors when the percent deterioration surpasses a threshold. As stated before all spools will produce different results regardless of age so each spool will have a different healthy linear regression equation.

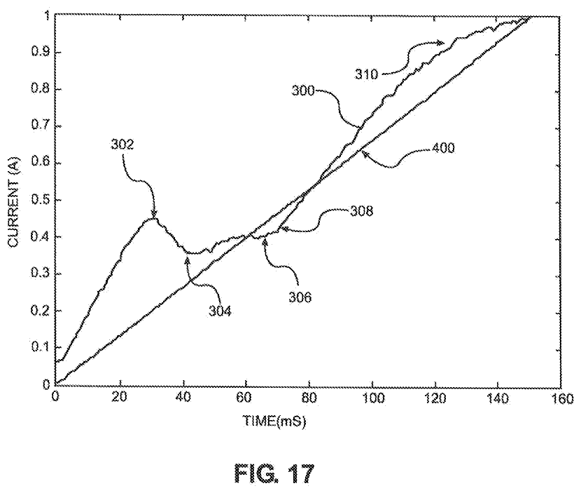

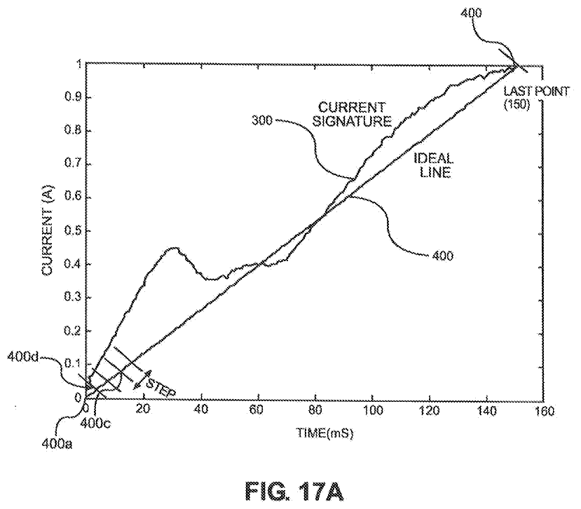

Referring to FIGS. 17 to 22, a variation of the above-described approach for detecting spool performance deterioration is presented in which spool response time deterioration and spool position deterioration are assessed to detect spool performance deterioration. By detecting spool performance deterioration, potential spool failures can be predicted before they occur which in turn allows for the prediction of valve failures before they occur. By using such an approach, unplanned downtime of the vale and the machine using the valve, caused by the unexpected failure of a solenoid operated spool valve, can be reduced. As much of the description relating to the approach shown at FIGS. 1-16 is fully applicable to this example, the same concepts will not be repeated here where such overlap occurs. Further, the concepts presented for this example can be incorporated with the concepts presented at FIGS. 1-16.

In the example presented at FIGS. 17 to 22, the disclosed approach involves predicting the progression of the failure occurring in spool valve which, in-turn, involves predicting failure of valves due to spool faults. The extent to which the failure be predicted in advance, depends on the accuracy of detection system. Hence it is necessary to detect spool faults early. Spool failure has two aspects: (1) spool position deterioration (restricted movement of the spool) resulting in reduced flow output; and (2) spool response time deterioration resulting in complete movement of spool giving full flow, but time taken to achieve final position of spool is more than specified. Either of these conditions can happen individually or both can co-exist at given instant. Further, either condition alone can cause a spool failure or operation below a desired performance level. Therefore, by monitoring both conditions simultaneously, an improved assessment of the overall health of the spool valve can be achieved.

Referring to FIG. 17, an actual current signature 300 and an ideal current line 400 for the coil 132 is shown, showing current plotted against time. In one aspect, the current signature 300 includes a first peak 302, a first valley 304, a last valley 306, a minimum point from the ideal line 308, and a 90% of max current value point 310.

A number of useful features may be extracted from the current signature 300 and ideal current line 400 for used in detecting spool response time and position deterioration. For example, the features in the following paragraphs may be extracted:

Time to reach First Peak current: This is the difference between time when current command was given, and first peak 302 is observed on the current signature 300. This feature indicates start of the spool movement.

Time to reach Last Valley current: This is the difference between time when current command was given, and last valley 306 is observed on the current signature. This feature indicates end of spool movement.

Time to reach 90% of Maximum/Stable state current: This is the difference between time when current command was given, and 90% current of stable state value 310 is observed on the current signature. This feature shows characteristic change when spool response time and spool position get deteriorated.

Minimum point near zero from ideal line: Ideal line 400 is drawn as shown in FIG. 17, and shortest distance between this line and current signature (closest point on current signature below the line 308) is used as a feature. It too serves as indicator for completed spool movement.

Number of dip Points in current signature: This feature indirectly calculates all the small negative slopes in the current signature which are indications of mechanical movement in magnetic field.

Difference in ‘current at First valley’ and ‘stable state current’: This is difference in magnitude of the current seen at 1st valley 306 and stable state current. Depending on how much distance is travelled by spool, the magnitude of the valley gets affected and so does this difference.

Ratio of ‘square of current at first valley’ and ‘current at 1st Peak’: This derived feature monitors change happening in peak-valley region of the current signature.

Euclidean Distance between reference stuck profile and latest recorded current signature: This feature is used to monitor health of the valve by comparing latest recorded signature with a worst case (complete stuck) current signature.

Referring to FIG. 17, the determination of the ideal signature line 400 is presented in further detail. In one aspect, the ideal signature 400 line extends between a starting point 400a and an end point 400b, with a plurality of steps or samples 400c between. In one example, the ideal current signature 400 is captured for 150 mS in 150 instantaneous samples or steps 400c. To develop the ideal signature line 400, the current is first normalized. Subsequently, the steps 400c are calculated with the following equation:

Calculate: Step 400c=(1−first point of current signature 400d)/150.

With such step points the ideal line is drawn by cumulative addition of 150 steps. Accordingly, the ideal line 400 as well will have same number (150) points 400c. Once the ideal signature line 400 is developed, the above-described ‘minimum distance from ideal line near zero’ feature 308 can be calculated.

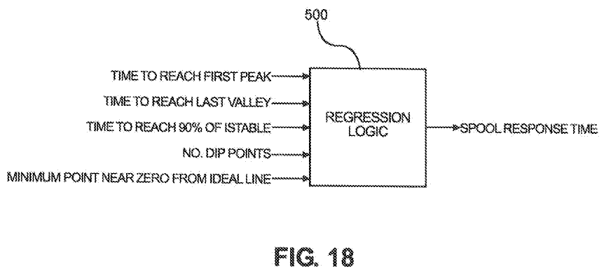

In one aspect, the above-described features can be used in an algorithm to detect spool response time deterioration. For example, the following features may be used: Time to reach First Peak current, Time to reach Last Valley current, Time to reach 90% of Maximum current, Number of dip points, and Minimum point near zero from ideal line. In one aspect, a wide range of Supervised Machine Learning techniques can be used to derive spool response time dependent variable) from extracted features from current signature (independent/explanatory variables). As schematically shown at FIG. 18, a linear regression, polynomial regression model(s) or module(s) 500 can be used to predict spool response time using the aforementioned features as inputs. Other methods may be used. In one aspect, linear/polynomial regression is used find out the strength of impact of these features on of spool performance. Regression analysis can yield a cause-and-effect relationship between time required for spool movement (dependent variable) and extracted features from current signature (independent/explanatory variables). With help of this knowledge, a best-fit predictive model to an observed data set of values can be developed. Consequently, each solenoid valve in its healthy state can be trained with the model and the corresponding Y value can be obtained from the regression model which serves as a reference to predict spool response time deterioration over the time.

As noted above, the regression model predicts a spool response time. In one example, the below equation shows one of the models obtained after regression which mostly indicates the feature coefficients.

Spool response time=X+(0.2X)*‘time to reach Last Valley’+(0.022X)*‘time to reach First Peak’+(0.081X)*‘time to reach 90% stable current’+(0.014)*‘number of dip points in current signature’+(0.053X)*‘minimum point near zero from ideal line’.

In one particular example, X is about 76.1. In one aspect, the above will yield the response time of the spool. Accordingly, the system can measure the spool response time as a regression output and then calculate the response deterioration in percent changed from the measured response time and the response time from the trained responses, as follows:

% Deterioration in spool response time at x instant=100*abs((response time calculated at time of training−response time calculated at x'th instant)/(response time calculated at time of training))

By using a root mean square error method to assess the goodness-of-fit measure of the linear regression model, the predictive model has been shown to have an R2 score of over 98% with a root mean square error below 3.0 achieved, with the predictive model using the above described inputs and calculations.

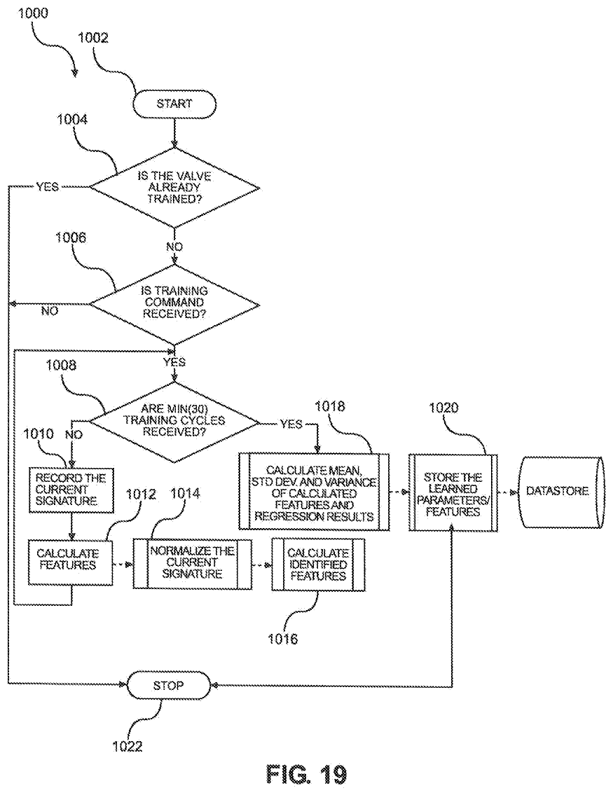

Referring to FIG. 19, an online learning flow chart for a process 1000 of the spool response time deterioration detection algorithm is presented. In a step 1002, the process is initiated either automatically or by command. In a step 1004, an evaluation is made as to whether the valve has been already trained. If yes, the process terminates at step 1022. If the valve is not trained, the process proceeds to step 1006 where it is assessed whether a training command has been received. If not, the process terminates at step 1022. If yes, the process proceeds to step 1008 where it is determined whether a minimum number of training cycles in which the valve current signature has been stored has been achieved. In one example, a minimum of 30 training cycles must be received before proceeding. If the minimum number of training cycles has not been achieved, the process proceeds to step 1010 where the current signature is recorded in temporary memory. At step 1012, the aforementioned features of the current signature are calculated and the process loops back to step 1008 until the minimum number of training cycles has been achieved. At each step 1012, the current signature is also normalized at step 1014 and the identified features are calculated at step 1016. Once the minimum number of training cycles is achieved, the process proceeds to step 1018, where various further calculations are performed. For example, step 1018 can calculate mean values, standard deviation values, variance of calculated features, and regression results. At a step 1020, the learned parameters/features are stored in memory, for example permanent memory, after which the process terminates at step 1022.

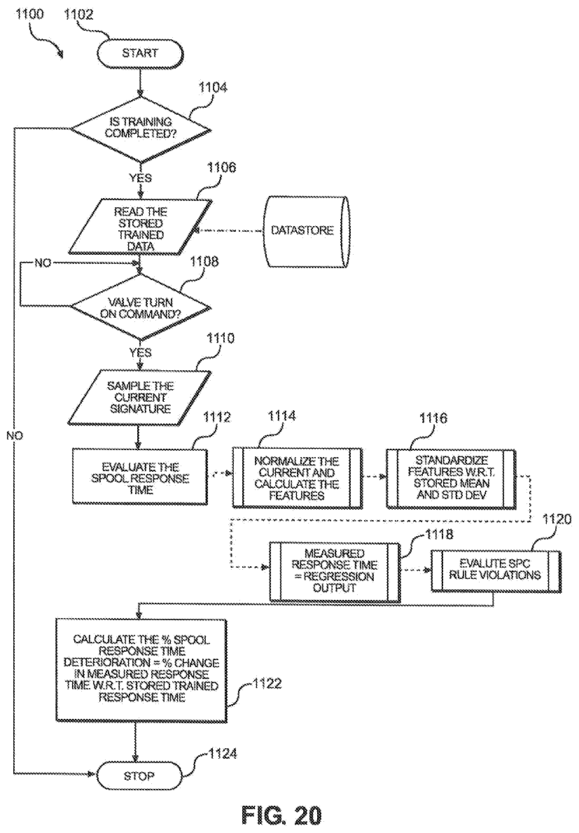

Referring to FIG. 20, a further process 1100 of the real time spool response time deterioration algorithm is presented. At a step 1102 the process initiates either automatically or by command. At step 1104, an evaluation is performed as to whether training has been completed (e.g. via process I 000), whereby the process is stopped at step 1124 if training has not been completed or advances to step 1106 if training has been completed. At step 1106, the stored trained data (e.g. from process 1000) is read. At a step 1108, the process will stay in a holding loop at step 1108 until a valve turn ON command has been verified, after which the process advances to step 1110 at which the current signature of the valve is sampled. In steps 1112 to 1120, spool response time is evaluated. The measured current signature is normalized, and features are calculated at step 1114. These features, at step 1116, are scaled by using standardization technique to transform features into common range by using mean and standard deviation stored in learning phase. This information is used in the regression model to calculate the response time at step 1118. Step 1120 can be implemented to evaluate SPC (Statistical Process Control) rule violations. The calculated response time is used to compute the percent spool response time deterioration as a percent change in measured response time with respect to the stored trained response time from process 1000. The process can terminate at step 1124.

The linear regression and polynomial regression logic model or module of FIG. 18 can also be used, with different inputs, to predict spool position using the following features: Difference in ‘current at 1st valley’ and ‘stable state current’; Euclidean Distance between reference stuck profile and latest recorded current signature; Time to reach First Peak current; Time to reach 90% of Maximum current; Time to reach Last Valley current; Ratio of ‘square of current at 1st valley’ and ‘current at 1st Peak’.

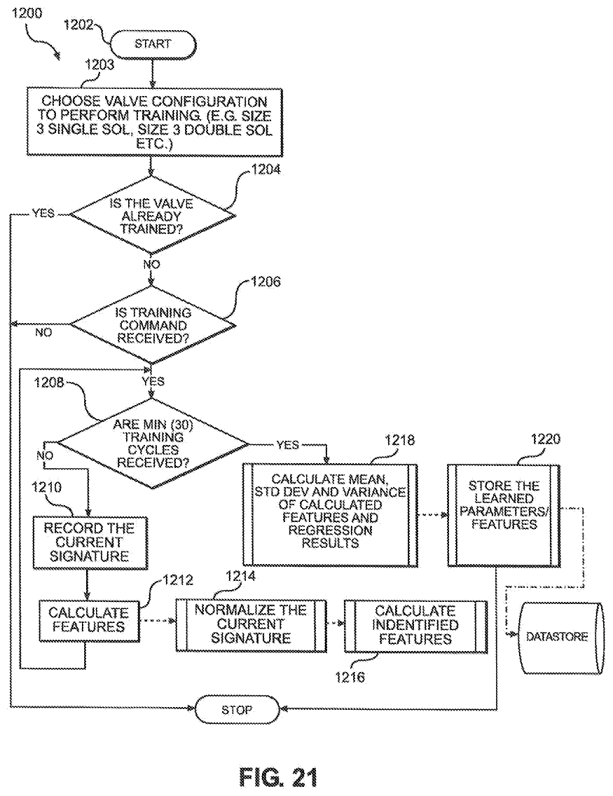

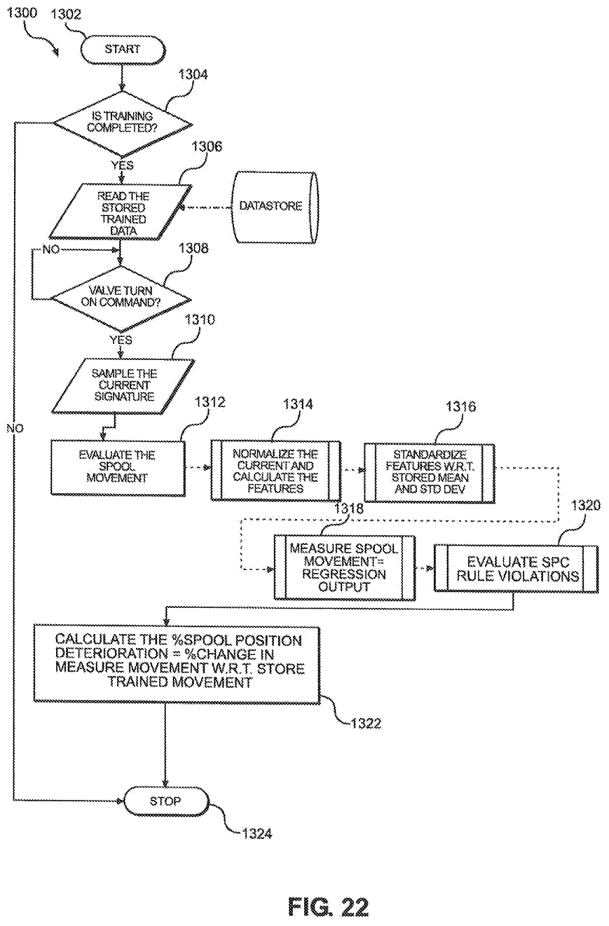

Various methods may be used to detect the spool position achieved of the valve. In one example, real time position is predicted with the use of pretrained models. There can be pretrained predictive models available from experimental data for different configurations of the valve (e.g. Eaton Corporation size 3 single solenoid spool valve, Eaton Corporation size 5 single solenoid spool valve, Eaton Corporation size 5 double solenoid spool valve, etc.). In one aspect, a wide range of supervised machine learning techniques can be used to derive completed spool movement (dependent variable) from extracted features from current signature (independent/explanatory variables). In the example linear regression is used. Linear regression gives cause-and-effect relationship between completed spool movement (dependent variable) and extracted features from current signature independent/explanatory variables). With help of this knowledge, a best fit predictive model to an observed data set of values can be developed depending on chosen valve's configuration. Each solenoid valve in its healthy state is trained with this model and corresponding Y is obtained from the regression model which serves as a reference to predict spool position deterioration over the time. In one aspect, an advantage of this method is features which are used to predict completed spool movement remains the same irrespective of the configuration of the solenoid operated spool valve, only the coefficients of features in machine learning model changes. Refer FIG. 21 and FIG. 22 for more details on the process for learning and testing.

Using a regression model approach to predict ‘completed spool position’ for this method, the completed spool position can be calculated with the following equation:

Completed spool position=X+(0.575X)*‘diff first valley and I stable’+(0.601X)*‘Euclidean Distance’+(0.222X)*‘time to reach first peak’−(0.584X)*‘time to reach90% stable current’−(0.117X)*‘time to reach Last Valley’+(0.236X)*‘ratio of First valley square to first peak’

The above equation will output a completed spool movement. In one particular example, X is about 2.229. Accordingly, the system measures the completed spool movement as a regression output and then calculates the position deterioration in percent changed from the measured completed position and the position from the trained responses with the below equation:

% Deterioration in spool position at x instant=100*abs((spool movement calculated at time of training−spool movement calculated at x'th instant)/(spool movement calculated at time of training))

By using a root mean square error method to assess the goodness-of-fit measure of the linear regression model, the predictive model has been shown to have an R2 score of over 99% with a root mean square error below 0.1 achieved, with the predictive model using the above described inputs and calculations.

Referring to FIG. 21, an online learning flow chart for a process 1200 of the spool position deterioration detection algorithm is presented. Where the process 1000 is also implemented, it is noted that process 1000 and process 1200 can be consolidated into a single process while recording and calculating the necessary information and features for ascertaining spool response time and position deterioration. In a step 1202, the process is initiated either automatically or by command. In a step 1203, a valve configuration is chosen or identified for training. It is noted that a similar step can be incorporated into process 1000. In a step 1204, an evaluation is made as to whether the valve has been already trained. If yes, the process terminates at step 1222. If the valve is not trained, the process proceeds to step 1206 where it is assessed whether a training command has been received. If not, the process terminates at step 1222. If yes, the process proceeds to step 1208 where it is determined whether a minimum number of training cycles in which the valve current signature has been stored has been achieved. In one example, a minimum of 30 training cycles must be received before proceeding. The minimum number of cycles can be the same or different for processes 1000 and 1200. If the minimum number of training cycles has not been achieved, the process proceeds to step 1210 where the current signature is recorded in temporary memory. At step 1212, the aforementioned features of the current signature are calculated and the process loops back to step 1208 until the minimum number of training cycles has been achieved. At each step 1212, the current signature is also normalized at step 1214 and the identified features are calculated at step 1216. Once the minimum number of training cycles is achieved, the process proceeds to step 1218, where various further calculations are performed. For example, step 1218 can calculate mean values, standard deviation values, variance of calculated features, and regression results. At a step 1220, the learned parameters/features are stored in memory, for example permanent memory, after which the process terminates at step 1222.

Referring to FIG. 22, a further process 1300 of the real time spool position deterioration algorithm is presented. At a step 1302 the process 1302 initiates either automatically or by command. At step 1304, an evaluation is performed as to whether training has been completed (e.g. via process 1200), whereby the process is stopped at step 1324 if training has not been completed or advances to step 1306 if training has been completed. At step 1306, the stored trained data (e.g. from process 1200) is read. At a step 1308, the process will stay in a holding loop at step 1308 until a valve turn ON command has been verified, after which the process advances to step 1310 at which the current signature of the valve is sampled. In steps 1312 to 1320, spool position movement is evaluated. The measured current signature is normalized, and features are calculated at step 1314. These features, at step 1316, are scaled by using standardization technique to transform features into common range by using mean and standard deviation stored in learning phase. This information is used in the regression model to calculate the spool movement at step 1318. Step 1320 can be implemented to evaluate SPC (Statistical Process Control) rule violations. The calculated spool movement is used to compute the percent spool position deterioration as a percent change in measured movement with respect to the stored trained movement from process 1200. The process can terminate at step 1324.

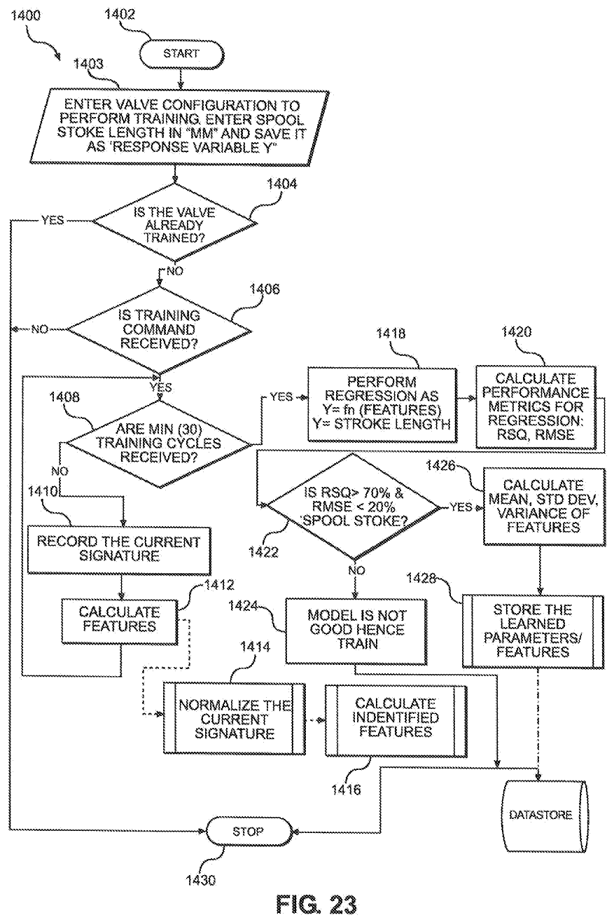

FIG. 21 and FIG. 22 discuss flow chart for ‘spool position deterioration detection’ when pretrained models are available for required spool operated solenoid valve configuration. For example, when valve configuration is chosen at step 1203, the algorithm will know which pretrained model (coefficients of regression) should be used as baseline healthy for real time evaluation of spool position deterioration). A self-learning regression model mentioned is another method which can be used to find a healthy baseline for ‘spool position deterioration detection’ when we do not have pretrained models for required spool operated solenoid valve configuration. In that case, the regression model (coefficients of regression) can be learned in online learning phase, as outlined at FIG. 23. In such an approach, the Real time evaluation of ‘spool position deterioration’ will be the same as described in relation to FIG. 22 once a healthy baseline is identified for that valve configuration in the online learning phase.

Referring to the details of FIG. 23, a process 1400 of the spool position deterioration detection algorithm is presented. Where the process 1000 is also implemented, it is noted that process 1000 and process 1400 can be consolidated, in whole or in part, into a single process while recording and calculating the necessary information and features for ascertaining spool response time and position deterioration. In a step 1402, the process is initiated either automatically or by command. In a step 1403, a valve configuration is chosen or identified for training. It is noted that a similar step can be incorporated into process 1000. In a step 1404, an evaluation is made as to whether the valve has been already trained. If yes, the process terminates at step 1430. If the valve is not trained, the process proceeds to step 1406 where it is assessed whether a training command has been received. If not, the process terminates at step 1430. If yes, the process proceeds to step 1408 where it is determined whether a minimum number of training cycles in which the valve current signature has been stored has been achieved. In one example, a minimum of 30 training cycles must be received before proceeding. The minimum number of cycles can be the same or different for processes 1000 and 1400. If the minimum number of training cycles has not been achieved, the process proceeds to step 1410 where the current signature is recorded in temporary memory. At step 1412, the aforementioned features of the current signature are calculated and the process loops back to step 1408 until the minimum number of training cycles has been achieved. At each step 1412, the current signature is also normalized at step 1414 and the identified features are calculated at step 1416. Once the minimum number of training cycles is achieved, the process proceeds to step 1418, where various further calculations are performed. For example, step 1418 can perform regression as Y=fn (features), Y=stroke length, and step 1420 can calculate performance metrics for regression, for example, Rsq (R squared), RMSE (root mean square error). At a step 1422 the Rsq and RMSE are compared to the spool stroke to determine if the model is good not good. In one example, the model is good if Rsq is greater than 70% and the RMSE is less than 20% of spool stroke. Where these parameters are not met, the process terminates at step 1430. Where the parameters are met, the process moves to step 1426 where further calculations are performed, for example, calculate mean values, standard deviation values, variance of calculated features, and regression results. At a step 1428, the learned parameters/features are stored in memory, for example permanent memory, after which the process terminates at step 1430.

By using the above processes, both spool response time deterioration and spool position deterioration can be simultaneously assessed with change values in comparison to a baseline (e.g. modeled value). Both of these deteriorations may be expressed as a percent change, percent error, percent difference, and/or an actual or absolute change in the value. In some examples, the system monitors both the spool response time and position deterioration change values and compares them to threshold values. In some examples, an alert or signal is generated when either one of the spool position or response time change value exceeds a threshold value, for example a predetermined threshold value. For example, a signal can be generated and transmitted over a vehicle CAN-Bus system indicating that the valve should be evaluated, serviced, or replaced. In some examples, an alert or signal is generated when both the spool position and response time change values exceed respective thresholds. With such an approach failures of the spool valve can be prevented before they occur.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed:

1. A solenoid operated valve comprising:
at least one coil and at least one regulating member;
a controller that interfaces with an electrical current meter to monitor a current signature of the coil upon actuating the solenoid operated valve by operating the solenoid operated valve in an actuating mode in which a first power level is used to drive current through the coil thereby moving the regulating member; and
the controller including a processor and memory in electronic communication with the processor for executing a power optimization algorithm operable to:
detect when the regulating member has begun to shift based on a sensed current of the current signature sensed by the electrical current meter;
detect when the regulating member has reached a final position based on the sensed current of the current signature sensed by the electrical current meter; and
shift the solenoid operated valve from the actuating mode to a hold mode once the regulating member has been determined to be in the final position, wherein when the solenoid operated valve is operated in the hold mode a second power level is used to drive current through the coil, and wherein the second power level is lower than the first power level.

2. The valve of claim 1, wherein the second power level of the hold mode is controlled by a pulse width modulation controller.

3. The valve of claim 1, wherein the controller includes an integrated circuit with the solenoid coil.

4. The valve of claim 1, wherein the controller detects the regulating member has begun to shift by detecting when the current has switched from a positive to a negative slope.

5. The valve of claim 1, wherein the controller detects that the regulating member has reached its final position by detecting that the current has switched from a positive slope, to a negative slope and then back to a positive slope.

6. The valve of claim 5, wherein the controller uses a first latch which is set to high output when the system detects a negative slope, when the controller detects a positive slope after the first latch's output state has been set to high, the controller uses a second latch which is then set to high;
once both the first and second latches are set to high the controller switches the current to a hold state.

7. The valve of claim 1, wherein the regulating member is a spool.

8. A solenoid operated valve comprising:
at least one coil and at least one regulating member;
a controller that interfaces with an electric current meter to monitor a current signature of the coil upon actuating the solenoid operated valve and:
the controller monitoring measured data from the electric current meter related to the current signature, the measured data including measured operation values comprising:
time required to reach a first peak in current;
time required to reach a first valley in current;
time required to reach the maximum current output;
the ratio of the time required to reach the first valley to the time required to reach the first peak; and
wherein the controller compares the measured operational values to baseline operational values stored in memory to monitor the health of the solenoid operated valve.

9. The valve of claim 8, wherein the controller stores data from at least two complete regulating member actuations and creates a linear regression equation based on the data stored.

10. The valve of claim 9, wherein if wherein the baseline operational values correspond to a healthy regulating member, and wherein if the measured operational values deviate from the baseline operational values by a predetermined amount.

11. The valve of claim 9, wherein an error is generated if any one of the measured operational values deviates from its corresponding baseline operation value by a predetermined amount.

12. The valve of claim 9, wherein an error is generated if a sum of a plurality of the measured operational values deviates from a sum of a plurality of corresponding baseline operational values by a predetermined amount.

13. The valve of claim 10, wherein the controller stores data from at least two regulating member actuations to create the baseline operational values.

14. The valve of claim 10, wherein each feature is monitored by statistical process control or SPC.

15. A method of training a solenoid valve comprising:
checking if the system is already trained;
if the system is not trained recording the current signature;
calculating feature values;
repeating the above cycle until the system is trained.

16. The method of claim 13, wherein if the system is trained the system stops.

17. The method of claim 13, wherein once a threshold number of cycles is complete the system calculates the mean and variance of calculated features and regression results.

18. A method for reducing unplanned downtime for a solenoid operated spool valve, the method comprising:
a) determining a response time of a spool of the spool valve;
b) determining a position of the spool of the spool valve;
c) calculating a spool response time error value;
d) calculating a spool valve position error value;
e) comparing one or both of the spool response time error value and the spool valve position error value to threshold values;
f) generating an error signal when either or both of the spool response time error value and the spool valve position error value exceeds the threshold values.

19. The method of claim 18, wherein the step of determining a response time of the valve includes calculating a response time based on one or more of:
a) a time to reach first peak current;
b) a time to reach last valley current;
c) a time to reach 90% of maximum current;
d) a number of dip points; and
e) a minimum point near zero from an ideal current signature line.

20. The method of claim 19, wherein the calculating a response time step is performed with a regression model.

21. The method of claim 19, wherein the calculating a spool response time error value includes comparing the valve response time to a baseline response time.

22. The method of claim 21, wherein the baseline response time is determined during a training of the spool valve.

23. The method of claim 21, wherein the spool response time error is calculated as a percent change with respect to the baseline response time.

24. The method of claim 18, wherein the step of determining a position of the spool
a) a Euclidian distance between a reference stuck profile and a latest recorded current signature;
b) a time to reach first peak current;
c) a time to reach last valley current;
e) a time to reach 90% of maximum current; and
f) a ratio of the square of the current at a first valley and a current at the first peak

25. The method of claim 24, wherein the calculating a position step is performed with a regression model.

26. The method of claim 24, wherein the calculating a position error value includes comparing the valve position to a baseline response time.

27. The method of claim 26, wherein the baseline response time is determined during a training of the spool valve.

28. The method of claim 26, wherein the spool response time error is calculated as a percent change with respect to the baseline response time.
